(19) United States
(12) Patent Application Publication
(10) Pub. No.: US 2006/0080610 A1
(43) Pub. Date: Apr. 13, 2006

(54) Methods, systems and computer program products for outline views in computer displayable presentations

(76) Inventor: David L. Kaminsky, Chapel Hill, NC (US)

Correspondence Address: Robert N. Crouse;Myers Bigel Sibley & Sajovec, P.A., P. O. Box 37428, Raleigh, NC, 27627, US

(21) Appl. No.: 10/963,154

(22) Filed: Oct. 12, 2004

(51) Int. Cl. G06F 3/00

(52) U.S. Cl. 715/730

(57) ABSTRACT

Methods of providing a computer displayable presentation can include allowing insertion of outline section breaks into an outline view of a computer displayable presentation including a sequence of slides. A multi-level hierarchical outline view of the computer displayable presentation can be provided, wherein different levels of the multi-level hierarchical outline view are separated by the inserted outline section breaks. Related systems and computer program products are also disclosed.

### FIELD OF THE INVENTION

This invention relates to methods, systems, and computer program products for processing information, and more particularly, to methods, systems, and computer program products for computer displayable presentations.

### BACKGROUND

It is known to create computer displayable presentations by creating what are commonly referred to as “slides” using a software package such as PowerPoint® available from Microsoft Incorporated, Inc of Redmond, Wash. Some software packages can provide an “outline view” in a frame adjacent to and separate from a main display frame, where the adjacent frame depicts a summary view associated with slides shown in the main display frame during the presentation. Once the slides have been created, the software package may be used to provide the presentation wherein the slides are displayed to an audience according to a sequence.

Unfortunately, presentations to audiences may proceed in a nonlinear fashion. For example, in some contexts it may be advantageous for a presenter to skip some slides or even entire sections of the presentation in response to a question from the audience. Moreover, it may be desirable that this type of nonlinear sequence in the presentation be done as seamlessly and professionally as possible. In addition, when creating a set of charts, it is often desirable to view the charts nonlinearly.

It is known to address these types of nonlinear sequences by, for example, including slides in the presentation that are intended to introduce each section of the presentation in the outline with large oversized text so that a presenter can use a “slide sorter” view to easily recognize where sections start/end in the presentation whereupon the presenter can jump directly to the desired section without scrolling through a large number of slides in response to a question.

It is also known to include embedded links which, when clicked on, can display the slide to which the link is logically connected. However, such links must be embedded manually, and to each location to which the presenter may wish to jump. For example, if in response to a question, a presenter wishes to change from displaying the current slide to a another slide which addresses the particular question, the presenter may need an embedded link for each of the potential slides to which the jump is to be made. Such an approach may require extensive manual insertion of embedded links.

It is also known to provide an outline view in association with particular document formats such as PDF. In such approaches, it is known to provide a portion of document in a frame that is adjacent to a main display frame, where the adjacent frame depicts an outline view of the document and the main display frame shows the section of the document being displayed. However, it can be unwieldy to use such types of documents as the basis of a presentation, and they lack certain presentation features such as animation. Using document production software to create and view presentations is unwieldy, as indicated by the disparate products and markets for document and presentation software.

### SUMMARY

Embodiments according to the invention can provide methods, systems and computer program products for outline views in computer displayable presentations. Pursuant to these embodiments, a method of providing a computer displayable presentation can be include allowing insertion of outline section breaks into an outline view of a computer displayable presentation including a sequence of slides. A multi-level hierarchical outline view of the computer displayable presentation can be provided, wherein different levels of the multi-level hierarchical outline view are separated by the inserted outline section breaks.

In some embodiments according to the invention, section slides can be inserted into the multi-level hierarchical outline view corresponding to the inserted outline section breaks. In some embodiments according to the invention, a multi-level hierarchical reference to at least one of the inserted section slides is provided in at least one of the slides.

In some embodiments according to the invention, a direct transition from a first slide to a second slide is allowed responsive to selection of the multi-level hierarchical reference, wherein the first and second slides are separated in the sequence by at least two other slides. In some embodiments according to the invention, providing a multi-level hierarchical reference can include providing the multi-level hierarchical reference during run-time of the presentation. In some embodiments according to the invention, the multi-level hierarchical reference is displayed only on a presenter's screen during run-time of the presentation.

### BRIEF DESCRIPTION OF THE DRAWINGS

FIG. 1 is a schematic illustration of a multi-level hierarchical outline view of computer displayable presentation according to some embodiments of the invention.

FIGS. 2A and 2B are schematic illustrations of multi-level hierarchical outline views of computer displayable presentation according to some embodiments of the invention.

FIG. 3 is a schematic illustration of the automatic insertion of outline section breaks to provide a multi-level hierarchical outline view of a computer displayable presentation according to some embodiments of the invention.

FIG. 4 is a schematic illustration of a slide included in the computer displayable presentation according to some embodiments of the invention.

FIG. 5 is a flow chart that illustrates operations of some embodiments according to the invention.

FIG. 6 is a schematic illustration of an outline view of a computer displayable presentation according to some embodiments of the invention.

### DETAILED DESCRIPTION OF EMBODIMENTS ACCORDING TO THE INVENTION

The present invention now will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be understood that, although the terms first, second, etc. may be used herein to describe various elements, these elements should not be limited by these terms. These terms are only used to distinguish one element from another. For example, a first portion could be termed a second portion, and, similarly, a second portion could be termed a first portion without departing from the teachings of the disclosure.

As will be appreciated by one of skill in the art, the present invention may be embodied as methods, systems, and/or computer program products. Accordingly, the present invention may take the form of an entirely hardware embodiment, an entirely software embodiment or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Computer program code or “code” for carrying out operations according to the present invention may be written in an object oriented programming language such as JAVA®, Smalltalk or C++, JavaScript, Visual Basic, TSQL, Perl, or in various other programming languages. Software embodiments of the present invention do not depend on implementation with a particular programming language. Portions of the code may execute entirely on one or more systems utilized by an intermediary server.

The code may execute entirely on one or more servers, or it may execute partly on a server and partly on a client within a client device or as a proxy server at an intermediate point in a communications network. In the latter scenario, the client device may be connected to a server over a LAN or a WAN (e.g., an intranet), or the connection may be made through the Internet (e.g., via an Internet Service Provider). It is understood that the present invention is not TCP/IP-specific or Internet-specific. The present invention may be embodied using various protocols over various types of computer networks.

The present invention is described below with reference to block diagram and flowchart illustrations of methods, systems and computer program products according to embodiments of the invention. It is understood that each block of the illustrations, and combinations of blocks in the illustrations can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block and/or flowchart block or blocks.

These computer program instructions may be stored in a computer-readable memory that can direct a computer or other programmable data processing apparatus to function in a particular manner, such that the instructions stored in the computer-readable memory produce an article of manufacture including instruction means which implement the function specified in the block diagrams and/or flowchart block or blocks.

The computer program instructions may be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block diagrams and/or flowchart block or blocks.

Embodiments according to the invention can operate in a logically separated client side/server side-computing environment, sometimes referred to hereinafter as a client/server environment. The client/server environment is a computational architecture that involves a client process (i.e., a client) requesting service from a server process (i.e., a server). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

A client can be a program, such as a web browser, that requests information, such as web pages, from a server under the control of a user. Examples of clients include browsers such as Netscape Navigator® (America Online, Inc., Dulles, Va.) and Internet Explorer® (Microsoft Corporation, Redmond, Wash.). Browsers typically provide a graphical user interface for retrieving and viewing web pages, web portals, applications, and other resources served by Web servers. A SOAP client can be used to request web services programmatically by a program in lieu of a web browser.

The applications provided by the service providers may execute on a server. The server can be a program that responds to the requests from the client. Some examples of servers are International Business Machines Corporation's family of Lotus Domino® servers, the Apache server and Microsoft's Internet Information Server (IIS) (Microsoft Corporation, Redmond, Wash.).

The clients and servers can communicate using a standard communications mode, such as Hypertext Transport Protocol (HTTP) and SOAP. According to the HTTP request response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

As described herein in greater detail, in some embodiments according to the invention, outline section breaks can be inserted into an outline view of a computer displayable presentation, which includes a sequence of slides. Inserting the outline section breaks can provide a multi-level hierarchical outline view of the computer displayable presentation in which different levels of the hierarchy are separated by the inserted outline section breaks. For example, a slide included in a computer displayable presentation can provide a multi-level hierarchical outline view shown in a display frame, which may be viewed by an audience of the presentation. Furthermore, the multi-level hierarchical outline view can include references to multi-level portions of the multi-level hierarchical in the computer displayable presentation. The references to the multi-level hierarchical outline view may enable the presenter to more seamlessly transition from one section of the presentation to another by, for example, activating (or “clicking on”) the references included in the outline view itself, rather than referring to a frame that is adjacent to the main display frame.

The multi-level hierarchical references may be provided only on a screen viewed by the presenter rather than as part of a general display that is visible to the audience. This approach may enable the presenter to directly transition from one section to another without introducing the multi-level hierarchical references to the audience, which otherwise may be distracting. In still other embodiments, the multi-level hierarchical references may be visible to the audience. The outline view section breaks may be inserted automatically into the presentation based on, for example, a numbering system.

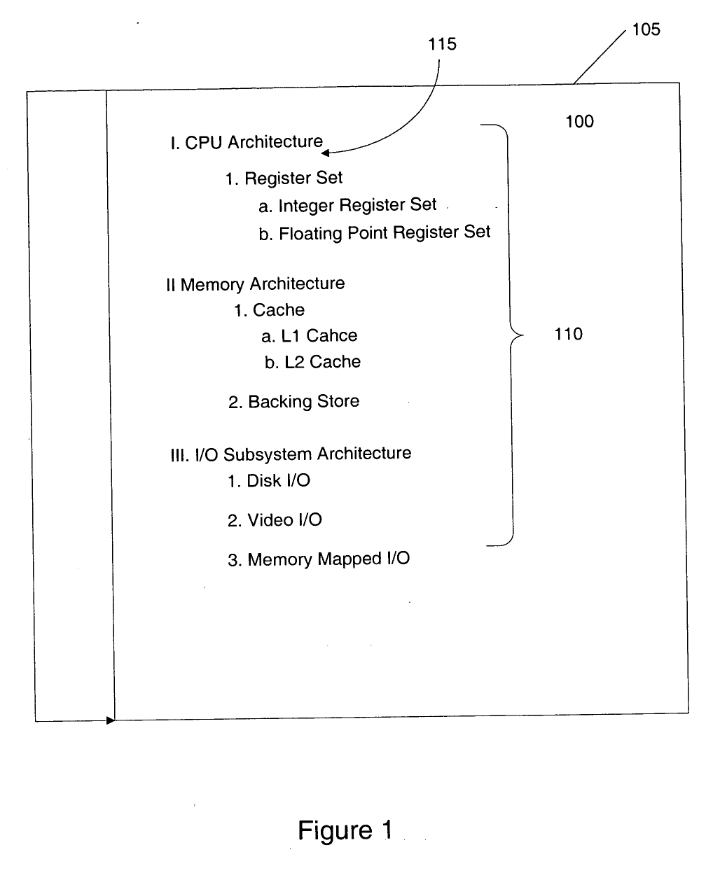

FIG. 1 is a schematic illustration of a slide 100 included in the computer displayable presentation according to some embodiments of the invention. According to FIG. 1, the slide 100 is shown in a main display frame 105 of the slide that can be provided using well-known software packages, such as Microsoft PowerPoint available from Microsoft, Inc. of Redmond, Wash. The slide 100 includes multiple levels of hierarchy (i.e., I, I.1, II, II.1.a, II.1.b, etc) in the outline view 110, wherein the hierarchical levels can be organized according to whatever logical organization the presenter deems appropriate for a particular presentation. As shown in FIG. 1, a top level of the multi-level hierarchy includes three sections, I-III: CPU Architecture, Memory Architecture, and IO Subsystem Architecture, respectively. Furthermore, each of the sections of the top level of the multi-level hierarchical outline view includes respective lower level sections s of the multi-level hierarchical outline view, such as “1. register set” found in the multi-level hierarchy beneath “I. CPU Architecture. It will be understood that the slides associated with each of the respective sections shown in FIG. 1 can be included in the presentation following the respective section. For example, slides regarding the specifics of the Integer Register Set located between sections I.1.b. and II. in the computer displayable presentation even though not shown in FIG. 1.

It will be understood that each of the different levels of the multi-level hierarchy in the outline view 110 in the slide 100 are separated by outline section breaks which indicate a change in hierarchy from one level to another. For example, referring to FIG. 1, an outline section break 115 located between section I. CPU architecture and section I.1. register set indicates that the slides associated with the register set are one level below the CPU Architecture section in the multi-level hierarchy of the presentation. It will be understood that, although not shown in FIG. 1, slides can be included between the enumerated multiple levels of the multi-level hierarchical outline view.

It will be understood that the multi-level hierarchical outline view associated with the computer displayable presentation can specify a sequence in which the slides of the presentation can be presented to an audience. In operation, slides located at different levels of the hierarchy can be directly accessed by a presenter without necessarily transitioning through intervening slides. For example, if while discussing the backing store in the memory architecture section of the presentation, an audience member requests clarification with respect to some material previously presented in the CPU architecture section, the presenter may directly access the section of the outline in which the pertinent material is located without displaying a reverse sequence of slides from the backing store of the section through the register section.

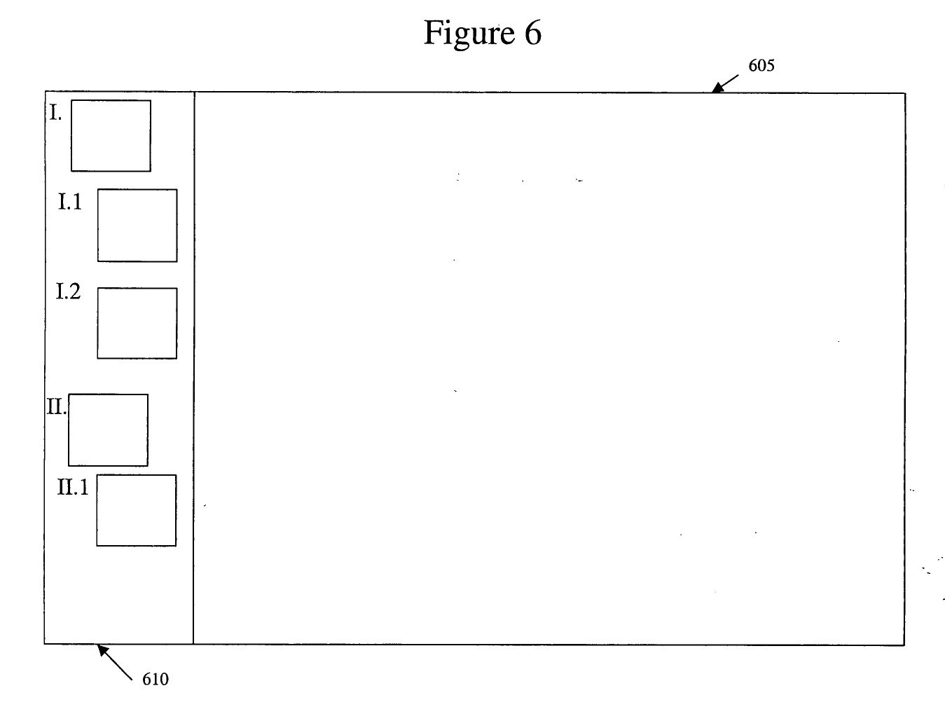

It will also be understood that embodiments according to the invention may be used when creating a presentation or at “run-time” when the computer displayable presentation is showed to an audience. In either type of embodiment according to the invention, the user/presenter can use the views provided to enable a more convenient way to jump between slides. FIG. 6 is a schematic outline view according to some embodiments of the invention that may be used to create computer displayable presentations. As shown in FIG. 6, the slide in a main display frame 605 is being created whereas an adjacent frame 610 shows a hierarchical “thumbnail-” view of the slides included in the computer displayable presentation. The hierarchical “thumbnail” view is organized to show the multiple levels of the hierarchy of the outline view. For example, the slides included at the highest level of the hierarchy (sections I. and II.) are left-hand justified in the adjacent frame 610, whereas the first level below the highest level of the hierarchy (sections I.1, I.2, and II.1) are indented relative to the highest level thereby indicating the relative levels of the hierarchy for the respective slides being created.

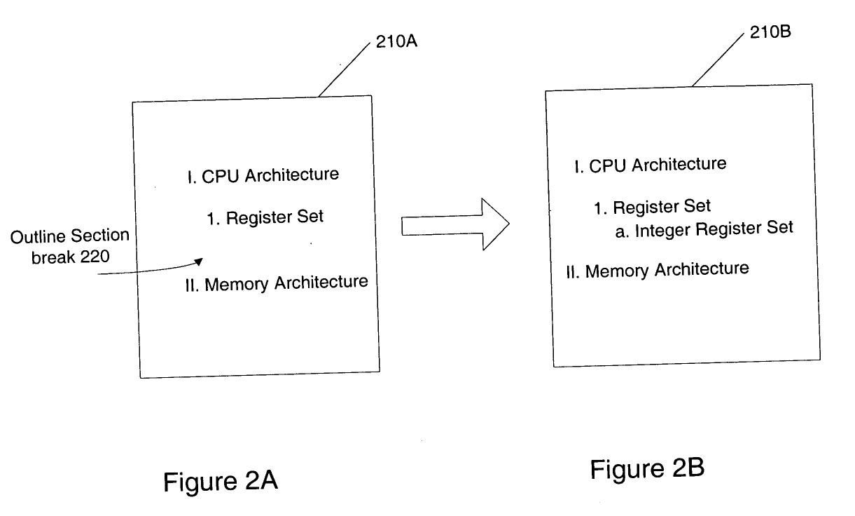

FIGS. 2A and 2B are schematic illustrations of the insertion of outline section breaks into a computer displayable presentation according to some embodiments of the present invention. As shown in FIG. 2A, an outline section break 220 is inserted into an outline view 210a that already includes multiple levels of hierarchy. In particular, the outline section break 220 is inserted between sections I.1. register set and II. Memory Architecture, which is beneath CPU Architecture in the multi-level hierarchy. Inserting the outline section break 220 indicates the addition of another level to the multi-level hierarchy as shown in FIG. 2B as Integer Register Set to provide a new outline view 210b including the new level of the hierarchy as I.1.a. Integer Register Set. As described above, inserting the outline section break 220 can provide a multi-level hierarchical outline view of the computer displayable presentation wherein the different levels of the multi-level hierarchical outline view 210b are separated by the inserted outline section break 220. It will also be understood that the outline section break 220 can be included in a slide that is inserted into the presentation, wherein the inserted slide includes, for example, the text that identifies the title of the new section introduced by the outline section break 220.

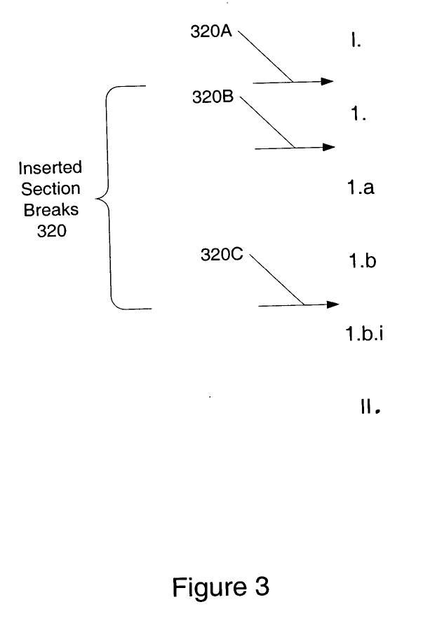

It will be understood that the outline section breaks could be inserted either manually or automatically. In some embodiments according to the invention, where the outline section breaks are inserted automatically, the section breaks may be inserted using an outline view parsing module that identifies levels of hierarchy based on, for example, a predetermined numbering system associated with the different levels of hierarchy. In particular, FIG. 3 shows a schematic illustration of a multi-level hierarchy to be provided as part of a computer displayable presentation. Outline section breaks 320a-c can be inserted at the indicated places based on the predetermined references associated with different levels of the hierarchy. For example, I. can be associated with the uppermost level of the multi-level hierarchy, whereas 1.a., and i. can each be associated with successively lower levels of a multi-level hierarchy. Accordingly, when the outline view parsing module encounters numbers associated with the increasingly lower levels of the multi-level hierarchy, an outline section break can be automatically inserted into the computer displayable presentation to provide, for example, the multi-level hierarchical outline views depicted in FIGS. 1-2B.

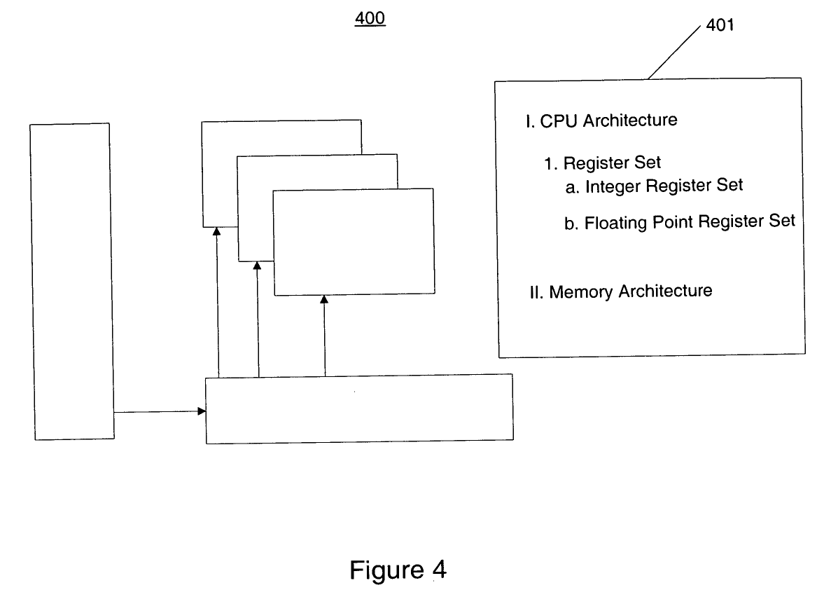

FIG. 4 is a schematic illustration of a slide 400 included in computer displayable presentation according to some embodiments of the invention. According to FIG. 4, the slide 400 includes a representation of a section of a presentation on Memory Architecture that is included in the computer displayable presentation beneath outline section II , as shown for example, in FIG. 1 (memory architecture). It will also be understood that the slide 400 includes multi-level hierarchical references to sections of the outline view included in the computer displayable presentation. For example, the multi-level hierarchical reference 401 (or “reference”) may appear only as part of the presenter's display and may be hidden from the audience's view so as to avoid distracting the audience with what may be unnecessary information.

In other embodiments according to the invention, the outline view may be visible to both the presenter and the audience. In operation, the presenter may activate (e.g., “click on”) one of the references 401 to cause the presentation to directly transition from the slide 400 to the slide or slides associated with the activated reference. For example, if during discussion of the memory architecture, an audience member asks a question related to the register sets found within the CPU, the presenter may transition the presentation directly from the memory architecture section to the section dealing with the register sets (i.e., I.1.) without displaying any intervening slides that may otherwise be shown during a sequential presentation. In some embodiments according to the invention, activating the reference 401 causes the presentation provided to skip over at least two slides.

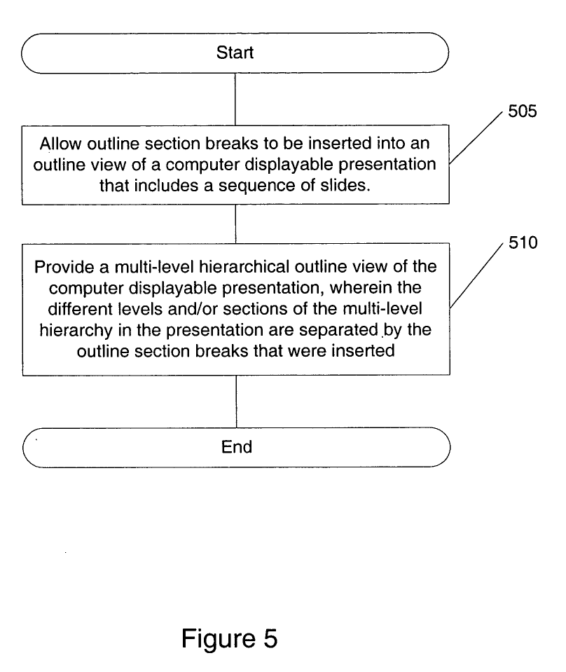

FIG. 5 is a flowchart that illustrates some embodiments according to the invention. According to FIG. 5, outline section breaks may be inserted into an outline view for a computer displayable presentation that includes a sequence of slides. In some embodiments according to the invention, the outline section breaks can be automatically inserted using, for example, an outline view parsing module. In other embodiments according to the invention, the outline section breaks can be inserted manually prior to run time (block 505).

The insertion of the outline section breaks into the outline view can provide a multi-level hierarchical outline view of the computer displayable presentation, wherein the different levels of the multi-level hierarchy in the presentation are separated by the outline section breaks that were inserted (block 510). In some embodiments according to the invention, the slides showing the multi-level hierarchical outline view can include multi-level hierarchical references to an insert in section slide. In other words, a slide included in the computer displayable presentation can include a reference that can be activated (i.e., by clicking thereon) for transitioning the presentation from one slide to another, wherein the slides are separated by at least two intervening slides.

As discussed above, outline section breaks can be inserted into an outline view of a computer displayable presentation, which includes a sequence of slides. Inserting the outline section breaks can provide a multi-level hierarchical outline view of the computer displayable presentation in which different levels of the hierarchy are separated by the inserted outline section breaks. For example, a slide included in a computer displayable presentation can provide a multi-level hierarchical outline view shown in a display frame, which may be viewed by an audience of the presentation. Furthermore, the multi-level hierarchical outline view can include references to multi-level portions of the multi-level hierarchical in the computer displayable presentation. The references to the multi-level hierarchical outline view may enable the presenter to more seamlessly transition from one section of the presentation to another by, for example, activating (or “clicking on”) the references included in the outline view itself, rather than referring to a frame that is adjacent to the main display frame.

The multi-level hierarchical references may be provided only on a screen viewed by the presenter rather than as part of a general display that is visible to the audience. This approach may enable the presenter to directly transition from one section to another without introducing the multi-level hierarchical references to the audience, which otherwise may be distracting. In still other embodiments, the multi-level hierarchical references may be visible to the audience. The outline view section breaks may be inserted automatically into the presentation based on, for example, a numbering system. In still other embodiments according to the invention, the outline may be hidden to both presenter and audience, and may be invoked through an input, such as right clicking on a particular area of the screen.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

What is claimed:

1. A method of providing a computer displayable presentation comprising:
allowing insertion of outline section breaks into an outline view of a computer displayable presentation including a sequence of slides; and
providing a multi-level hierarchical outline view of the computer displayable presentation, wherein different levels and/or sections of the multi-level hierarchical outline view are separated by the inserted outline section breaks.

2. A method according to claim 1 further comprising:
automatically inserting section slides into the multi-level hierarchical outline view corresponding to the inserted outline section breaks.

3. A method according to claim 1 further comprising:
providing a multi-level hierarchical reference to at least one of the inserted section slides in at least one of the slides.

4. A method according to claim 3 further comprising:
allowing direct transition from a first slide to a second slide responsive to selection of the multi-level hierarchical reference, wherein the first and second slides are separated in the sequence by at least two other slides.

5. A method according to claim 3 wherein providing a multi-level hierarchical reference comprises providing the multi-level hierarchical reference during run-time of the presentation.

6. A method according to claim 5 further comprising:
displaying the multi-level hierarchical reference only on a presenter's screen during run-time of the presentation.

7. A system for providing a computer displayable presentation comprising:
means for allowing insertion of outline section breaks into an outline view of a computer displayable presentation including a sequence of slides; and
means for providing a multi-level hierarchical outline view of the computer displayable presentation, wherein different levels and/or sections of the multi-level hierarchical outline view are separated by the inserted outline section breaks.

8. A system according to claim 7 further comprising:
means for automatically inserting section slides into the multi-level hierarchical outline view corresponding to the inserted outline section breaks.

9. A system according to claim 7 further comprising:
means for providing a multi-level hierarchical reference to at least one of the inserted section slides in at least one of the slides.

10. A system according to claim 9 further comprising:
means for allowing direct transition from a first slide to a second slide responsive to selection of the multi-level hierarchical reference, wherein the first and second slides are separated in the sequence by at least two other slides.

11. A system according to claim 9 wherein the means for providing a multi-level hierarchical reference comprises means for providing the multi-level hierarchical reference during run-time of the presentation.

12. A system according to claim 11 further comprising:
means for displaying the multi-level hierarchical reference only on a presenter's screen during run-time of the presentation.

13. A computer program product for providing a computer displayable presentation comprising a computer readable medium having computer readable program code embodied therein, the computer readable program product comprising:
computer readable program code configured to allow insertion of outline section breaks into an outline view of a computer displayable presentation including a sequence of slides; and
computer readable program code configured to provide a multi-level hierarchical outline view of the computer displayable presentation, wherein different levels and/or sections of the multi-level hierarchical outline view are separated by the inserted outline section breaks.

14. A computer program product according to claim 13 further comprising:
computer readable program code configured to automatically insert section slides into the multi-level hierarchical outline view corresponding to the inserted outline section breaks.

15. A computer program product according to claim 13 further comprising:
computer readable program code configured to provide a multi-level hierarchical reference to at least one of the inserted section slides in at least one of the slides.

16. A computer program product according to claim 15 further comprising:
computer readable program code configured to allow direct transition from a first slide to a second slide responsive to selection of the multi-level hierarchical reference, wherein the first and second slides are separated in the sequence by at least two other slides.

17. A computer program product according to claim 15 wherein the computer readable program code configured to provide a multi-level hierarchical reference comprises computer readable program code configured to provide the multi-level hierarchical reference during run-time of the presentation.

18. A computer program product according to claim 17 further comprising:
computer readable program code configured to display the multi-level hierarchical reference only on a presenter's screen during run-time of the presentation.
